(19) United States
(12) Patent Application Publication
(10) Pub. No.: US 2016/0027407 A1
(43) Pub. Date: Jan. 28, 2016

(54) METHODS AND SYSTEMS FOR COMPENSATING FOR TEMPERATURE-INDUCED CHANGES IN DISPLAY PERFORMANCE

(71) Applicant: Pixtronix, Inc., San Diego, CA (US)

(72) Inventors: Edward Buckley, Melrose, MA (US); Joyce Wu, Somerville, MA (US); Jignesh Gandhi, Burlington, MA (US)

(21) Appl. No.: 14/444,260

(22) Filed: Jul. 28, 2014

(51) Int. Cl. G09G 5/10; G06T 1/60; G09G 5/02; G09G 5/18; G09G 3/36; G09G 3/32

(52) U.S. Cl. CPC G09G 5/10; G09G 3/36; G09G 3/3208; G09G 5/02; G09G 5/18; G06T 1/60

(57) ABSTRACT

This disclosure provides systems, methods and apparatus for reducing flicker in display devices. In one image formation process, the controller can determine a number of subframes to be displayed for a subfield based on a temperature of a display apparatus. In some implementations, the controller can determine dithering parameters based on the determined number of subframes, and perform dithering on pixel intensity values based on the determined dithering parameters. In some implementations, a vector error diffusion technique can be utilized for performing dithering. In some implementations the controller can determine drive voltages for light modulators and drive currents for light sources used for displaying the subframes, based on the temperature of the display apparatus.

### TECHNICAL FIELD

This disclosure relates to the field of displays, and in particular, to image formation processes used by displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including an input configured to receive image data associated with an image frame, and control logic configured to derive a plurality of color subfields for displaying the image frame, determine a number of subframes within each color subfield to display the image frame based on a temperature signal indicative of a temperature within the apparatus, determine at least one dithering operating parameter based on the temperature signal, perform a dithering operation on at least one pixel intensity value based on the dithering operating parameter, generate the number of subframes based on the dithered at least one pixel intensity value, and output the generated subframes.

In some implementations, the apparatus further includes a temperature sensor for sensing the temperature of the apparatus and providing the temperature signal to the control logic. In some implementations, the temperature signal is indicative of a temperature within a fluid surrounding a plurality of display elements of the apparatus. In some implementations, the dithering operation includes a vector error diffusion algorithm performed within a vector color space. In some implementations, the control logic is further configured to determine a drive current for one or more light sources used for displaying the image frame based on the temperature signal.

In some implementations, the control logic is further configured to determine drive voltages for driving a plurality of light modulators of the apparatus based on the temperature signal. In some implementations, the control logic if further configured to determine data voltages and scan line voltages based on the temperature signal. In some implementations, the control logic is further configured to determine timings with which the subframes are outputted based on the temperature of the apparatus.

In some implementations, the apparatus further includes a display including the input, the control logic, the flicker control logic, the subfield and subframe generation logic and the output logic, a processor that is capable of communicating with the display, the processor being capable of processing image data, and a memory device that is capable of communicating with the processor. In some implementations, the display further includes a driver circuit capable of sending at least one signal to the display, and a controller capable of sending at least a portion of the image data to the driver circuit. In some implementations, the display further includes an image source module capable of sending the image data to the processor, wherein the image source module comprises at least one of a receiver, transceiver, and transmitter. In some implementations, the display further includes an input device capable of receive input data and to communicate the input data to the processor.

Another innovative aspect of the subject matter described in this disclosure can be implemented in a method for mitigating flicker in a display. The method includes receiving image data associated with an image frame, deriving a plurality of color subfields for displaying the image frame, obtaining a temperature signal indicative of a temperature within the display, determining a number of subframes for each color subfield to display the image frame based on the temperature signal, determining at least one dithering operating parameter based on the temperature signal, applying a dithering function on at least one pixel intensity value based on the dithering operating parameter, generating the number of subframes based on the dithered at least one pixel intensity value, and outputting the generated number of subframes for display.

In some implementations, applying a dithering function on the at least one pixel intensity value based on the dithering operation parameter includes applying vector error diffusion in a vector color space to the at least one pixel intensity value based on the dithering operation parameter. In some implementations, the dithering operation parameter includes the number of subframes. In some implementations, the method further includes determining a drive current for one or more light sources used for displaying the image frame based on the temperature signal. In some implementations, outputting the generated number of subframes includes determining timings with which the subframes are output based on the temperature signal.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a cross sectional view of an example display apparatus incorporating shutter-based light modulators.

FIG. 4 shows a block diagram of an example display apparatus.

FIG. 5 shows a block diagram of example control logic suitable for use in the display apparatus shown in FIG. 4.

FIG. 6 shows a flow diagram of an example process for generating an image on a display.

FIG. 7 shows a flow diagram of another example process for displaying an image frame.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In one image formation process, a controller can form an image by utilizing a set of color subfields and displaying subframes associated with each of the color subfields. In some implementations, the controller can determine a number of subframes to be displayed for a subfield based on a temperature within a display apparatus. In some implementations, the controller can determine dithering parameters based on the determined number of subframes, and perform dithering on pixel intensity values based on the determined dithering parameters. In some implementations, a vector error diffusion technique can be utilized for performing dithering. In some implementations the controller can determine drive voltages for light modulators and drive currents for light sources used for displaying the subframes, based on the temperature of the display apparatus.

Particular implementations of the subject matter described in this disclosure can be implemented to realize one or more of the following potential advantages. In general, image formation apparatus and processes disclosed herein mitigate display abnormalities caused due to changes in temperature of the display. In some implementations, temperature dependent changes in the speed of operation of light modulators of a display can be accounted for by adjusting a number of subframes used for displaying an image frame. In some implementations, dithering techniques, such as vector error diffusion techniques, can be utilized for reducing image artifacts.

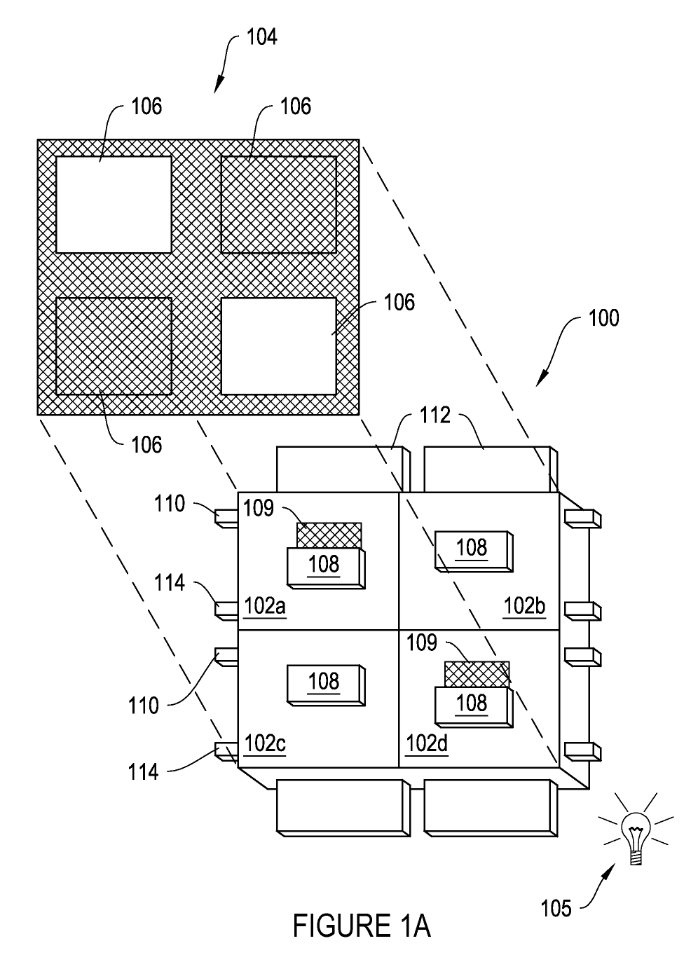

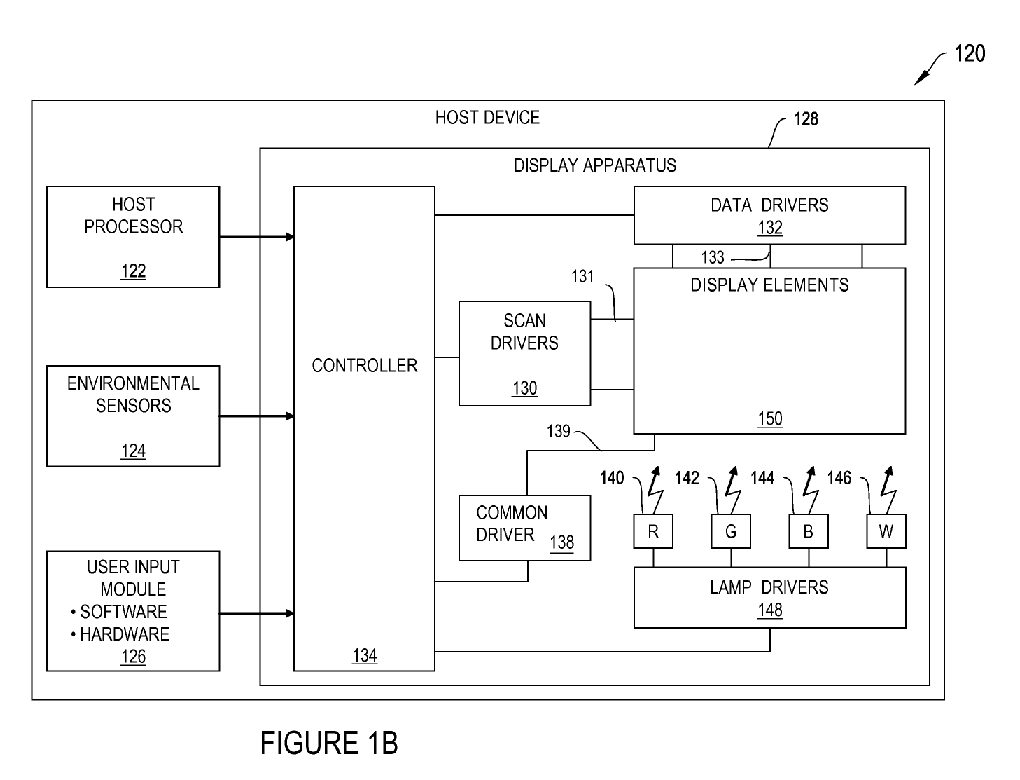

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent or glass substrates to facilitate a sandwich assembly arrangement where one substrate, containing the light modulators, is positioned over the backlight.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages results in the electrostatic driven movement of the shutters 108.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 conveys the personal preferences of the user to the controller 134, either directly, or via the host processor 122. In some implementations, the user input module 126 is controlled by software in which a user programs personal preferences, for example, color, contrast, power, brightness and content preferences. In some other implementations, these preferences are input to the host device 120 using hardware, such as a button, switch or dial, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

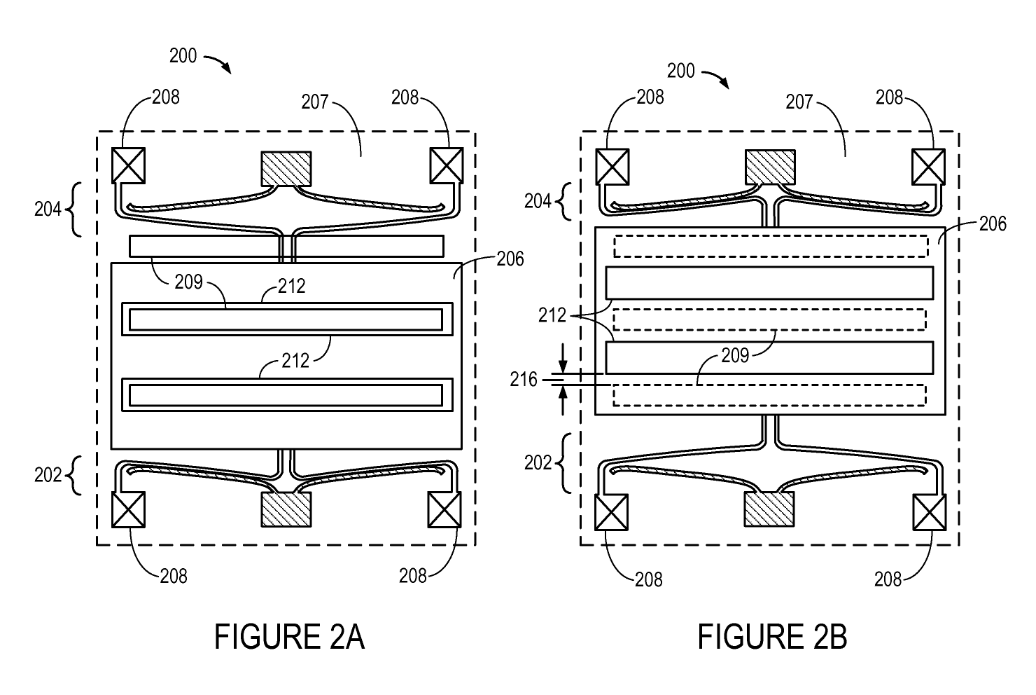

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

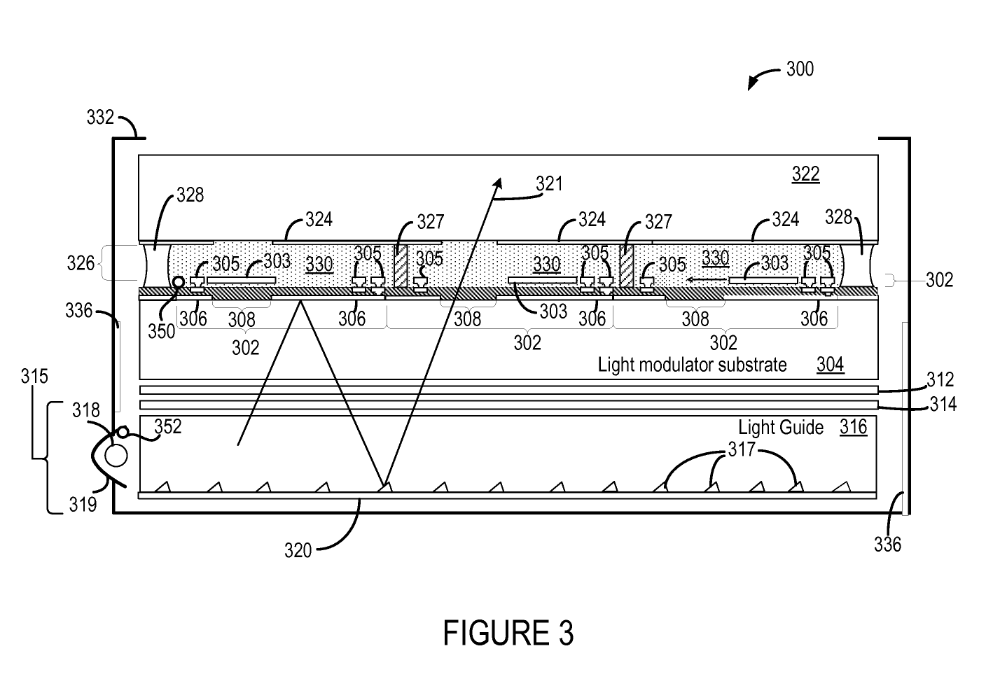

FIG. 3 shows a cross sectional view of an example display apparatus 300 incorporating shutter-based light modulators. As shown, the shutter based light modulators take the form of shutter assemblies 302, similar to the shutter assemblies 200 shown in FIGS. 2A and 2B. Each shutter assembly 302 incorporates a shutter 303 and anchors 305. Not shown are the compliant beam actuators which, when connected between the anchors 305 and the shutters 303, help to suspend the shutters 303 a short distance above the surface. The shutter assemblies 302 are disposed on a transparent substrate 304, such as a substrate made of plastic or glass. A rear-facing reflective layer, reflective film 306, disposed on the substrate 304 defines a plurality of surface apertures 308 located beneath the closed positions of the shutters 303 of the shutter assemblies 302. The reflective film 306 reflects light not passing through the surface apertures 308 back towards the rear of the display apparatus 300.

The display apparatus 300 includes an optional diffuser 312 and/or an optional brightness enhancing film 314 which separate the substrate 304 from a planar light guide 316. The light guide 316 includes a transparent material, such as glass or plastic. The light guide 316 is illuminated by one or more light sources 318. The light guide 316, together with the light sources 318 form a backlight. The light sources 318 can be, for example, and without limitation, incandescent lamps, fluorescent lamps, lasers or light emitting diodes (LEDs). A reflector 319 helps direct light from the light sources 318 towards the light guide 316. A front-facing reflective film 320 is disposed behind the light guide 316, reflecting light towards the shutter assemblies 302.

The light guide 316 includes a set of geometric light redirectors or prisms 317 which re-direct light from the light sources 318 towards the surface apertures 308 and hence toward the front of the display 300. The light redirectors 317 can be molded into the plastic body of light guide 316 with shapes that can be alternately triangular, trapezoidal, or curved in cross section. The density of the prisms 317 generally increases with distance from the light source 318.

A cover plate 322 forms the front of the display apparatus 300. The rear side of the cover plate 322 can be covered with a patterned light blocking layer 324 to increase contrast. The cover plate 322 is supported a predetermined distance away from the shutter assemblies 302 forming a cell gap 326. The cell gap 326 is maintained by mechanical supports or spacers 327 and/or by an adhesive seal 328 attaching the cover plate 322 to the substrate 304.

The adhesive seal 328 seals in a fluid 330. The fluid 330 can have a low coefficient of friction, low viscosity, and minimal degradation effects over the long term. The fluid immerses and surrounds the moving parts of the shutter assemblies 302, and can serve as a lubricant. In some implementations, the fluid 330 is a hydrophobic liquid with a high surface wetting capability. In some implementations, the fluid 330 has a refractive index that is either greater than or less than that of the substrate 304. In some implementations, in order to reduce the actuation voltages, the fluid 330 has a viscosity below about 70 centipoise. In some other implementations, the liquid has a viscosity below about 10 centipoise. Liquids with viscosities below 70 centipoise can include materials with low molecular weights: below 4000 grams/mole, or in some cases below 400 grams/mole. Fluids that may be suitable as the fluid 330 include, without limitation, de-ionized water, methanol, ethanol and other alcohols, paraffins, olefins, ethers, silicone oils, fluorinated silicone oils, or other natural or synthetic solvents or lubricants. Useful fluids can also include polydimethylsiloxanes (PDMS), such as hexamethyldisiloxane and octamethyltrisiloxane, or alkyl methyl siloxanes such as hexylpentamethyldisiloxane. Additional useful fluids include alkanes, such as octane or decane, nitroalkanes, such as nitromethane, and aromatic compounds, such as toluene or diethylbenzene. Further useful fluids include ketones, such as butanone or methyl isobutyl ketone, chlorocarbons, such as chlorobenzene, and chlorofluorocarbons, such as dichlorofluoroethane or chlorotrifluoroethylene. Other suitable fluids include butyl acetate, dimethylformamide, hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

Referring back to FIG. 3, a sheet metal or molded plastic assembly bracket 332 holds the cover plate 322, the substrate 304, the backlight and the other component parts of the display apparatus 300 together around the edges. The assembly bracket 332 is fastened with screws or indent tabs to add rigidity to the combined display apparatus 300. In some implementations, the light source 318 is molded in place by an epoxy potting compound. Reflectors 336 help return light escaping from the edges of the light guide 316 back into the light guide 316. Not depicted in FIG. 3 are electrical interconnects which provide control signals as well as power to the shutter assemblies 302 and the lamps 318.

The display apparatus 300 is referred to as the MEMS-up configuration, where the MEMS-based light modulators are formed on a front surface of the substrate 304, i.e., the surface that faces toward the viewer. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to in this configuration as the aperture plate. In the MEMS-down configuration, the substrate that carries the MEMS-based light modulators takes the place of the cover plate 322 in the display apparatus 300 and is oriented such that the MEMS-based light modulators are positioned on the rear surface of this top substrate, i.e., the surface that faces away from a viewer and toward the light guide 316.

In some implementations, the display apparatus 300 can include a temperature sensor 350. The temperature sensor can be utilized for measuring the temperature within the display apparatus 300. In some implementations, such as that shown in FIG. 3, the temperature sensor 350 can be placed within the display apparatus 300 such that the temperature sensor 350 can sense the temperature within the cell-gap 326. The temperature within the cell-gap 326 may often differ from an ambient temperature due to, for example, solar loading and/or heat generated by the electronic devices within the display apparatus 300. For example, the temperature sensor 350 can be inserted into the cell-gap 326 to make contact with the fluid 330. In some other implementations, the temperature sensor 350 can be located at any other portion of the display apparatus 300. In some implementations, the temperature sensor 350 can be fabricated on or coupled to the cover plate 322 or the light modulator substrate 304. In some implementations, the temperature sensor 350 can include a thermocouple or thermistor based temperature sensor. In some implementations, the display apparatus 300 can include a plurality of temperature sensors, such as the temperature sensor 350, distributed at various locations within the display apparatus 300. For example, the display apparatus 300 can include an additional temperature sensor 352 located in the vicinity of the light source 318. As the light sources 318 are located outside of the cell gap 326 and may themselves generate heat, the temperature of the light sources 318 may differ from the temperature within the cell-gap 326 or ambient to the display apparatus 300. Interconnects or wires from these temperature sensors can be provided to appropriate circuitry.

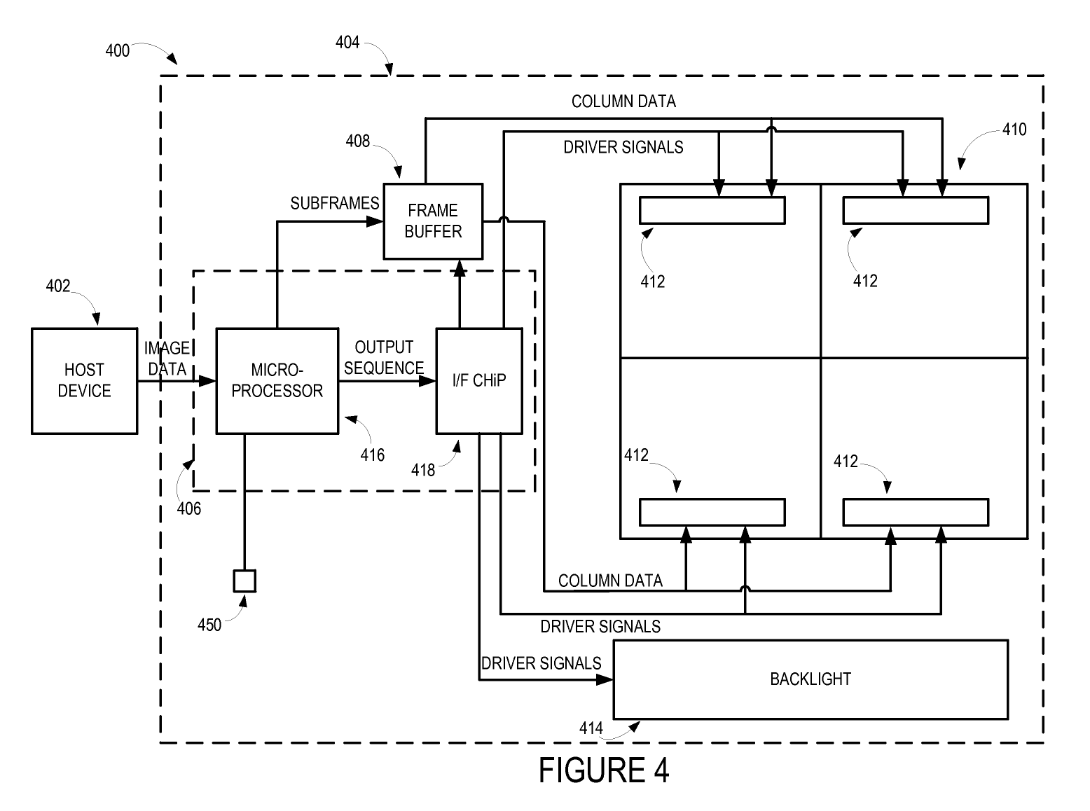

FIG. 4 shows a block diagram of an example display apparatus 400. The display apparatus 400 includes a host device 402 and a display module 404. The host device can be any of a number of electronic devices, such as a portable telephone, a smartphone, a watch, a tablet computer, a laptop computer, a desktop computer, a television, a set top box, a DVD or other media player, or any other device that provides graphical output to a display. In general, the host device 402 serves as a source for image data to be displayed on the display module 404.

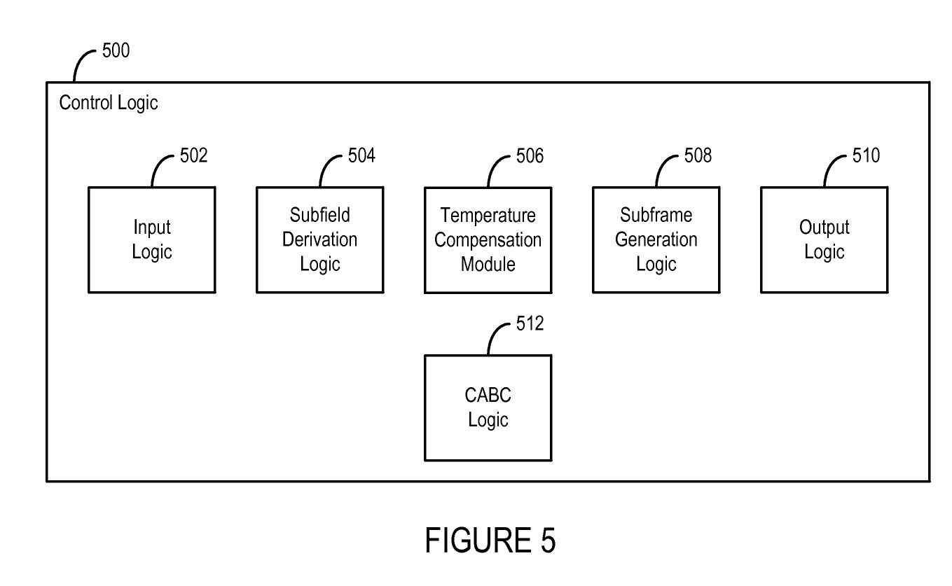

The display module 404 further includes control logic 406, a frame buffer 408, an array of display elements 410, display drivers 412 and a backlight 414. In general, the control logic 406 serves to process image data received from the host device 402 and controls the display drivers 412, array of display elements 410 and backlight 414 to together produce the images encoded in the image data. The functionality of the control logic 406 is described further below in relation to FIGS. 5-7.

In some implementations, as shown in FIG. 4, the functionality of the control logic 406 is divided between a microprocessor 416 and an interface (I/F) chip 418. In some implementations, the interface chip 418 is implemented in an integrated circuit logic device, such as an application specific integrated circuit (ASIC). In some implementations, the microprocessor 416 is configured to carry out all or substantially all of the image processing functionality of the control logic 406. In addition, the microprocessor 416 can be configured to determine an appropriate output sequence for the display module 404 to use to generate received images. For example, the microprocessor 416 can be configured to convert image frames included in the received image data into a set of image subframes. Each image subframe can be associated with a color and a weight, and includes desired states of each of the display elements in the array of display elements 410. The microprocessor 416 also can be configured to determine the number of image subframes to display to produce a given image frame, the order in which the image subframes are to be displayed, and parameters associated with implementing the appropriate weight for each of the image subframes. These parameters may include, in various implementations, the duration for which each of the respective image subframes is to be illuminated and the intensity of such illumination. These parameters (i.e., the number of subframes, the order and timing of their output, and their weight implementation parameters for each subframe) can be collectively referred to as an “output sequence.”

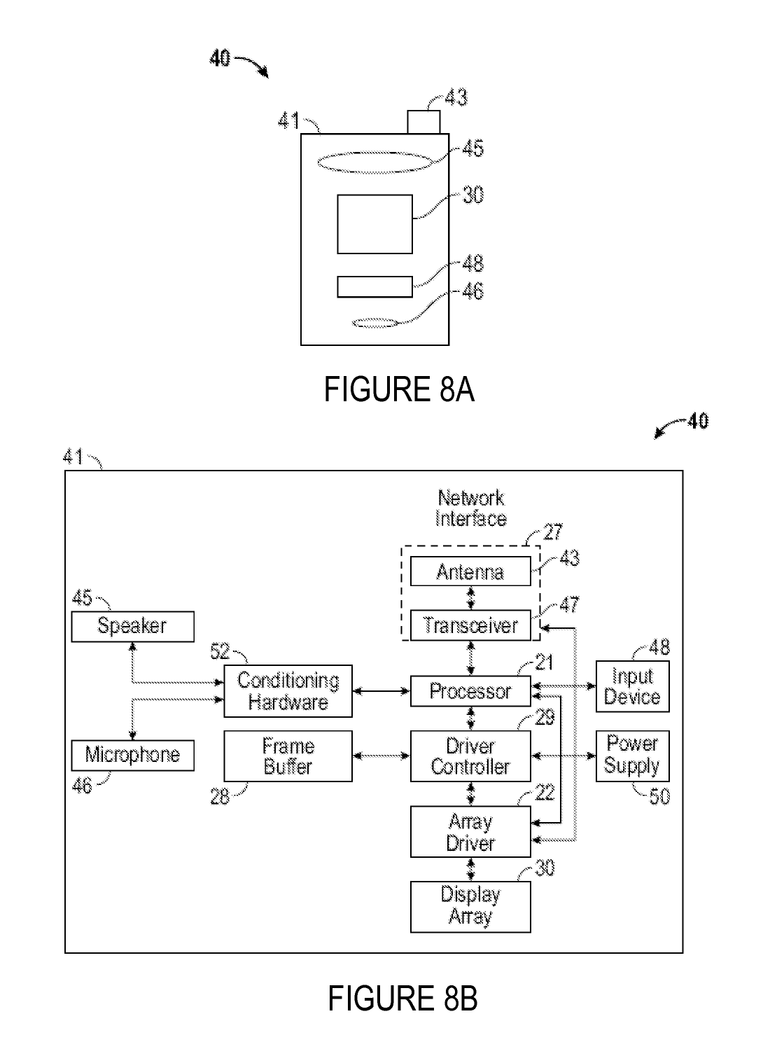

The interface chip 418 can be configured to carry out more routine operations of the display module 404. The operations may include retrieving image subframes from the frame buffer 408 and outputting control signals to the display drivers 412 and the backlight 414 in response to the retrieved image subframe and the output sequence determined by the microprocessor 416. The frame buffer 408 can be any volatile or non-volatile integrated circuit memory, such as DRAM, high-speed cache memory, or flash memory (for example, the frame buffer 408 can be similar to the frame buffer 28 shown in FIG. 8B). In some other implementations, the interface chip 418 causes the frame buffer 408 to output data signals directly to the display drivers 412.

In some other implementations, the functionality of the microprocessor 416 and the interface chip 418 are combined into a single logic device, which may take the form of a microprocessor, an ASIC, a field programmable gate array (FPGA) or other programmable logic device. For example, the functionality of the microprocessor 416 and the interface chip 418 can be implemented by a processor 21 shown in FIG. 8B. In some other implementations, the functionality of the microprocessor 416 and the interface chip 418 may be divided in other ways between multiple logic devices, including one or more microprocessors, ASICs, FPGAs, digital signal processors (DSPs) or other logic devices.

The array of display elements 410 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS based light modulators, or light emitters, such as OLED emitters, configured for use with a time division gray scale image formation process.

The display drivers 412 can include a variety of drivers depending on the specific control matrix used to control the display elements in the array of display elements 410. In some implementations, the display drivers 412 include a plurality of scan drivers similar to the scan drivers 130, a plurality of data drivers similar to the data drivers 132, and a set of common drivers similar to the common drivers 138, all shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 404, the control matrix used to control the display elements in the array of display elements 410 is segmented into multiple regions. For example, the array of display elements 410 shown in FIG. 4 is segmented into four quadrants. A separate set of display drivers 412 is coupled to each quadrant. Dividing a display into segments in this fashion reduces the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, which is illuminated by one or more lamps. Such display elements can be fabricated on transparent substrates, made, for example, from glass. In some implementations, the display drivers 412 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 414 can include a light guide, one or more light sources (such as LEDs), and light source drivers. The light sources can include light sources of multiple primary colors, such as red, green, blue, and in some implementations white. The light source drivers are configured to individually drive the light sources to a plurality of discrete light levels to enable illumination gray scale and/or content adaptive backlight control (CABC) in the backlight. For example, CABC can include dynamically normalizing the intensity values of one or more subfields such that the maximum intensity value in each normalized subfield is scaled to the maximum intensity value output by the display and scaling down the illumination levels of the corresponding LEDs, accordingly. The light guide distributes the light output by light sources substantially evenly beneath the array of display elements 410. In some other implementations, for example for displays including reflective display elements, the display apparatus 400 can include a front light or other form of lighting instead of a backlight. The illumination of such alternative light sources can likewise be controlled according to illumination grayscale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

In some implementations, the display module 404 can include or be coupled to a temperature sensor 450. The temperature sensor 450 can be utilized for sensing the temperature of the display apparatus. In some implementations, the temperature sensor 450 can be similar to the temperature sensor 350 discussed above in relation to the display apparatus 300 shown in FIG. 3. In some implementations, the temperature sensor 450 can output a voltage, current, or electrical output corresponding to the sensed temperature. As discussed below, the microprocessor 416 can utilize the temperature sensor 450 in determining the temperature of the display apparatus. This temperature information can be used by the microprocessor 416 to adjust various display parameters of the display apparatus 400.

FIG. 5 shows a block diagram of example control logic 500 suitable for use as, for example, the control logic 406 in the display apparatus 400 shown in FIG. 4. More particularly, FIG. 5 shows a block diagram of functional modules executed by the microprocessor 416. Each functional module can be implemented as software in the form of computer executable instructions stored on a tangible computer readable medium, which can be executed by the microprocessor 416 or by an ASIC. The control logic 500 includes input logic 502, subfield derivation logic 504, temperature compensation logic 506, subframe generation logic 508, and output logic 510. In some implementations, the control logic 500 may also include CABC logic 512. While shown as separate functional modules in FIG. 5, in some implementations, the functionality of two or more of the modules may be combined into one or more larger, more comprehensive modules.

The input logic 502 is configured to receive the input image data as a stream of pixel intensity values, and present the pixel intensity values to other modules within the control logic 500. The subfield derivation logic 504 can derive color subfields (e.g., red, green, blue, white, etc.) based on the pixel intensity values. The temperature compensation logic 506 can generate information, based on the temperature of the display, which can be used in generating an output sequence. The subframe generation logic 508 can generate subframes for each of the color subfields based on the output sequence and the pixel intensity values. The CABC logic 512 can implement CABC techniques for reducing power consumption. The output logic 510 can coordinate with one or more of the other logic components to determine an appropriate output sequence, and then use the output sequence to display the subframes on the display.

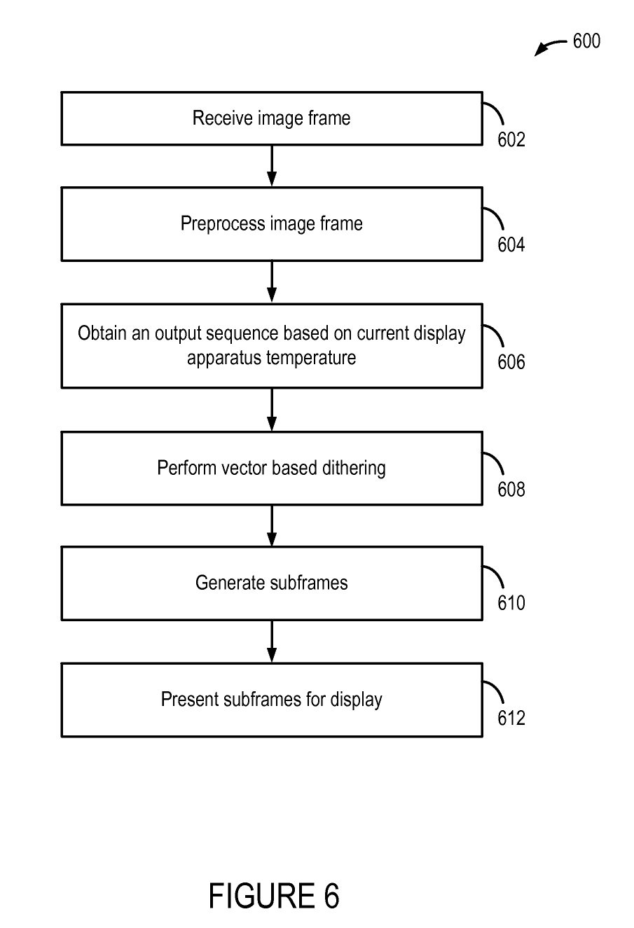

In some implementations, when executed by the microprocessor 416, the components of the control logic 500, along with the interface chip 418, display drivers 412, and backlight 414 (all shown in FIG. 4), function to carry out a method for generating an image on a display, such as the process 600 shown in FIG. 6. The functionality of the components of the control logic 500 is described further in relation to various operations carried out as part of the process 600.

FIG. 6 shows a flow diagram of an example process 600 for generating an image on a display. The process 600 includes receiving an image frame (stage 602), preprocessing the image frame (stage 604), obtaining an output sequence based on current display temperature (stage 606), performing vector based dithering (stage 608), generating subframes (stage 610), and presenting subframes for display (stage 612).

Referring to FIGS. 1B and 3-6, the process 600 includes the input logic 502 receiving image data in the form of image frames (stage 602). Typically, such image data is obtained by the input logic 502 as a stream of intensity values for the red, green, and blue components of each pixel in an image frame. The intensity values typically are received as binary numbers. The image data may be received directly from an image source, such from an electronic storage medium incorporated into the display apparatus 128. Alternatively, it may be received from a host processor 122 incorporated into the host device 120 in which the display apparatus 128 is built.

In some implementations, the process 600 includes preprocessing the received image frame (stage 604). For example, in some implementations, the image data includes color intensity values for more pixels or fewer pixels than are included in the display apparatus 128. In such cases, the input logic 502, the subfield derivation logic 504, or other logic incorporated into the controller 500 can scale the image data appropriately to the number of pixels included in the display apparatus 128. In some other implementations, the image frame data is received having been encoded assuming a given display gamma. In some implementations, if such gamma encoding is detected, logic within the controller 500 applies a gamma correction process to adjust the pixel intensity values to be more appropriate for the gamma of the display apparatus 128. For example, image data is often encoded based on the gamma of a typical liquid crystal (LCD) display. To address this common gamma encoding, the controller 500 may store a gamma correction lookup table (LUT) from which it can quickly retrieve appropriate intensity values given a set of LCD gamma encoded pixel values. In some implementations, the LUT includes corresponding RGB intensity values having a 16 bit-per-color resolution, though other color resolutions may be used in other implementations.

In some implementations, image frame preprocessing (stage 604) includes a dithering stage. In some implementations, the process of de-gamma encoding an image results in 16 bit-per-color pixel values, even though the display apparatus 128 may not be configured for displaying such a large number of bits per color. A dithering process can help distribute any quantization error associated with converting these pixel values down to a color resolution available to the display, such as 4, 5, 6, or 8 bits per color.

In some implementations, the image preprocessing (stage 604) can include the subfield derivation logic 504 selecting a set of color subfields for displaying the image frame. In some implementations, the selected color subfields can include frame independent contributing colors (FICCs) such as, without limitations, the colors red (R), green (G), blue (B), white (W), yellow (Y), magenta (M), cyan (C), or one or more combinations thereof. FICCs are selected independently of the image content or data associated with the image frame. In some implementations, the FICCs can include composite colors that are formed from the combination of two or more other FICCs. In some implementations, the subfield derivation logic may select an additional subfield color (also referred to as the “x-channel”) whose color is a composite of at least two colors associated with at least two of the other subfields. The color selected for the x-channel can be selected based on the contents of the image frame displayed and/or one or more prior image frames. For example, the subfield generation logic 504 can select colors such as, but not limited to, white, yellow, cyan, magenta, or any other color within the display's color gamut, as the x-channel color.

Once the color subfields are selected, the subfield generation logic 504 can generate initial pixel intensity values for each selected subfield color for all pixels. For example, the subfield generation logic 504 can adjust the pixel intensity values for the R, G, and B subfield colors based on the pixel intensity values selected for the x-channel. For example, if selected x-channel color is white, then the subfield generation logic 504 can select a pixel intensity value that can be equally subtracted from each of the R, G, and B color pixel intensity values and assign that value as the x-channel pixel intensity value. For example, if the pixel intensity values for a pixel were: R=100, G=200, and B=155, the subfield generation logic 504 can subtract 100 from the pixel intensity values for each color and assign 100 as the pixel intensity value for the x-channel. The resultant adjusted pixel intensity values for the R, G, and B colors would be 0, 100, and 55, respectively. In some implementations, the subfield generation logic 504 can subtract a fraction of the highest pixel intensity value that can be equally subtracted from each of the R, G, and B pixel intensity values. For example, continuing the above example, the subfield generation logic 504 can subtract 50 from the pixel intensity values of each color (0.5 times the highest possible value), resulting in pixel intensity values of R=50, G=150, B=105, and white=50. The pixel intensity values for each of the selected color subfields can be used as initial pixel intensity values for the generation of the output sequence, as described further below.

The process 600 further includes the temperature compensation module 506, in conjunction with the output logic 510, obtaining a temperature based output sequence to use in displaying the received image (stage 606). An output sequence for a given image frame includes a series of events for displaying a series of subframes associated with the image frame. In some implementations, the output sequence can include a series of data and control signals to drivers, such as the data drivers 132, scan drivers 130 and lamp drivers 148 shown in FIG. 1B. For example, the output sequence can include a sequence of events for outputting subframes along with timing information related to each event. Each subframe represents a set of data identifying desired display element states for display elements in multiple rows and multiple columns of the display. The output sequence can also include the intensities and time periods of the appropriate light sources to be illuminated during each subframe.

In some implementations, the generation of the output sequence can be based on the current temperature of the display apparatus. As discussed above in relation to FIG. 3, the display apparatus 300 can include a temperature sensor 350 for monitoring the temperature within the display apparatus 300. In some implementations, a change in temperature within the display apparatus 300, and in particular a change in the temperature of the fluid 330 within the cell gap 326, can affect the operation of the shutters 303. Specifically, a change in temperature of the fluid 330 can cause a change in the viscosity of the fluid. For example, a decrease in the temperature may increase the viscosity of the fluid 330. An increase in the viscosity of the fluid 330 may, in turn, increase the damping that the shutters 303 experience when moving between OPEN and CLOSED states. This increase in the resistance experienced by the shutters 303 may increase the switch time of the shutters 303.

A decrease in the temperature of the display apparatus 300 may also result in a decrease in the mobility of charge carriers within semiconductor devices used for driving the shutters 303. In some instances, the decrease in mobility of charge carriers reduces the speed of operation of the semiconductor devices. A reduction in the speed of operation of semiconductor devices used in circuits for driving the shutters 303 would, in turn, further decrease the overall speed of operation of the shutters 303.

On the other hand, an increase in the temperature of the display apparatus 300 may increase the speed of operation of both the shutters 303 and the circuitry driving the shutters 303. This increase in the speed of operation of the shutters 303 can be attributed to a decrease in the viscosity of the fluid 330 (which reduces the resistance that the shutters 303 experience) and the increase in the mobility of the charge carriers within semiconductor devices used in the circuitry that drives the shutters 303.

Changes in the speed of operation of the shutters 303 can impact the output sequence. As mentioned above, the output sequence includes timing information with respect to when, and for how long, each subframe is to be displayed. Generally, an image frame period can be divided into a number of time periods for displaying subframes. Further, the time periods allocated to each subframe can include a time period in which the shutters 303 are actuated (i.e., placing the shutters 303 in a desired state) based on the subframe data and a time period for illuminating light sources (such as red, green, blue, and white color light sources) after the shutters 303 have been actuated. An increase or decrease in the speed of operation of the shutters can impact the amount of time needed to actuate the shutters 303 into the desired state. In instances where less time is needed for the shutters 303 to be fully actuated (e.g., with an increase in the temperature), the temperature compensation module 506 can trigger a decrease in the length of the time periods allocated for shutter actuation. The additional available time can be utilized for improving the quality of the displayed image, reducing the power consumption of the display, or both. For example, in some implementations, the number of subframes displayed during an image frame can be increased, improving the quality of the image being displayed. In some implementations, the time period for displaying the subframes can be increased with a corresponding decrease in the illumination levels of the LEDs, reducing the power consumption of the display.

On the other hand, in instances in which more time is needed for the shutters 303 to be fully actuated (e.g., with a decrease in the temperature), the temperature compensation module 506 can trigger an increase in the length of the time periods allocated for shutter actuation. Doing so can result in a decrease in the amount of time for which each subframe can be illuminated—resulting in a dimmer image. In some implementations, to compensate for the decrease in the amount of time for illuminating subframes, the intensity of the light sources may have to be increased, resulting in a decrease in the power efficiency of the light sources.

In some implementations, the temperature compensation module 506 may reduce the number of subframes displayed during an image frame period in response to a sufficiently large decrease in the temperature of the display apparatus 300. As indicated above, decrease in the operating speed of the shutters 303 may warrant allocating a longer amount of time for the shutters 303 to achieve their intended state, resulting in shorter illumination times. In some instances, the increased power consumption needed to offset the decrease in the illumination time can be undesirable. To avoid the reduced power efficiency of the light sources, the temperature compensation module 506 can instead cause the output logic 510 to output fewer subframes for a subfield. Omitting one or more subframes saves the time needed to both load the data associated with that subframe as well as the time needed for illuminating the omitted subframe. This extra time can be reallocated to illuminate the remaining subframes at more power efficient intensity levels. In some implementations, the temperature compensation module 506 can omit one or more lower weighted frames. In some other implementations, the temperature compensation module 506 may omit any subframe or subframes of an image frame. In some implementations, omission of one or more subframes may impact the granularity with which pixel intensity values can be displayed, which may, in turn, impact the quality of the image being displayed. To limit the reduction in image quality, in some implementations, the subframes selected to be omitted are those subframes having the lowest weights, for example the least significant subframes associated with one or more color subfields. As discussed below, to compensate for the decrease in the quality of the displayed image, in some implementations, dithering (or error diffusion) techniques can be utilized for reducing the impact of reduced subframes on the image quality.

In some implementations, the temperature compensation logic 506 may select drive voltages output by driver circuits for driving the shutters 303 based on the temperature of the display apparatus 300. As mentioned above, the speed of operation of the shutters 303 may decrease with a decrease in the temperature of the display device. In some implementations, to maintain the speed of operation of the shutters 303 despite the decrease in temperature, the drive voltage provided to the shutters 303 can be increased. In some implementations, the drive voltage provided to the shutters 303 can also be increased to overcome the decreased mobility in the charge carriers of the semiconductor devices used in the drive circuits. In some implementations, the increase in the drive voltages may increase the actuation forces on the shutters 303. The increased actuation forces can compensate for the increased resistance from the fluid 330 experienced by the shutters 303 under decreased temperature conditions. In some implementations, other voltages, such as data voltages, scan line voltages, etc., may also be increased to improve the speed of operation of the circuitry of the display apparatus in general, and in particular the circuitry driving the shutters 303.

In some implementations, light emitted by the light sources may also be affected by the change in temperature of the display apparatus 300. For example, in some instances, the wavelength of the light emitted by one or more light sources, such as the light source 318 shown in FIG. 3, may change with the change in the temperature of the display apparatus 300. In some implementations, the temperature compensation logic 506 can adjust a drive current provided to the light sources to vary the wavelength of the light emitted by the light sources. In some implementations, the temperature compensation logic 506 can employ gamut mapping to adjust values in the color subfields to compensate for the change in the wavelength of the light emitted by one or more light sources.

The number, time periods, and weights of the subframes to be displayed based on the temperature of the display apparatus 300 can be stored in memory. For example, a look-up-table (LUT) including a list of temperatures and the corresponding values for the number, time periods, and weights of the subframes to be displayed for each subfield color can be stored in memory. In some implementations, the LUT can also include values for the drive voltages for the actuators of the shutters 303, the data voltages, the scan-line voltages, etc., and the drive currents for the light sources. In some implementations, these values can be predetermined using experimental data. In some implementations, for example, the values of the number of subframes stored in the LUT may decrease with the decrease in the temperature values. The output logic 510 in conjunction with the temperature compensation module 506 can generate the output sequence based on the values stored in the LUT.

In some implementations, the entire output sequence for various temperatures can be stored in a LUT. For example, the LUT can include a list of temperatures and the corresponding values for the entire output sequence. The values can include the values for the number, timing, and weights of the subframes, the drive currents for light sources, the drive voltages, the data voltages, the scan-line voltages, any gamut mapping functions, etc. The output logic 510 can then directly access the output sequence from the LUT based on the temperature signal provided by the temperature control logic 506 and output the subframes based on the accessed output sequence.

In some implementations, the CABC logic 512 may update subfield pixel intensity values using CABC. The CABC logic 512, after the subfields are derived, can normalize the intensity values in one or more of the subfields such that the maximum intensity value in each normalized subfield is scaled to the maximum intensity value output by the display. For example, in a display capable of outputting 256 gray scale levels, the subfield values are scaled such that the maximum intensity value therein is equal to 255. The illumination levels of the corresponding LEDs can be accordingly scaled down. The scaling factor for the LEDs can be used by the output logic 510 for adjusting the LED illumination levels.

Determining the output sequence can further include determining light source intensities for each of the light sources used for illuminating the display apparatus. In some implementations, the light source intensities (or LED intensities) can be a function of the color gamut used to form the image, the color of the subfields and any scaling factor determined by the CABC logic 512 discussed above. The control logic 500 can take into account these factors and generate appropriate light source intensity values that can be output with the output sequence.

The process 600 also includes performing dithering (stage 608). In some implementations, the selected output sequence can impact the granularity with which pixel intensity values can be displayed. For example, the granularity with which pixel intensity values can be displayed can deteriorate with a decrease in the number of lower weighted subframes utilized for displaying that pixel intensity. The decrease in the number of subframes may be a result of temperature compensation carried out by the temperature compensation logic 506. As a result, the pixel intensity displayed would not match the desired pixel intensity. This difference between the displayed pixel intensity and the desired pixel intensity can be described as a quantization error in the pixel intensity. As discussed above, in some implementations, a decrease in the temperature of the display apparatus 300 may result in the decrease in the number of subframe used for displaying the image frame. Thus, a decrease in the temperature of the display apparatus may result in an increase in quantization errors in the pixel intensities of the displayed image frame. The visual effect of these quantization errors can be reduced using error diffusion or other dithering algorithms. The temperature compensation logic 506 can determine and store in memory the number and weights of the subframes being used for displaying the image frame, which can be used as a dithering parameter by a dithering process.

In some implementations, dithering (or error diffusion) techniques can be utilized for reducing the impact of the quantization errors in the pixel intensities for an image frame. In some implementations, the temperature compensation module 506 can utilize vector error diffusion techniques to reduce the visual impact of pixel intensity quantization errors. A vector error diffusion technique operates on the pixel intensity values within a vector color space. For example, as discussed above, pixel intensities can be represented using RGB or RGBx pixel intensities within RGB or RGBx color spaces. The RGB or RGBx color spaces can be described as scalar color spaces. In some implementations, the pixel intensity values can also be described in vector color spaces. Examples of vector color spaces can include the XYZ color space, the L*a*b color space, the L*C*h color space, the hue-saturation-value (HSV) color space, the hue-saturation-lightness (HSL) color space, or any color space based on the Munsell color systems.

In some implementations, the vector error diffusion techniques transform the RGB or RGBx pixel intensity values into vector color space pixel intensity values and diffuse the quantization error for each pixel among neighboring pixels within the vector color space. Vector quantization error diffusion, unlike scalar error diffusion (which is carried out in a scalar colors space such as the RGB or RGBx color spaces), can diffuse quantization errors within pixel intensities of one color into pixel intensities of other colors. Diffusing the quantization error in this manner can reduce image artifacts that can negatively affect images that have been dithered using scalar error diffusion techniques. One examples of vector error diffusion techniques is presented in “Color Digital Halftoning Taking Colorimetric Color Reproduction into Account,” by Hideaki Haneishi, et al, in the Journal of Electronic Imaging 5(1), 97-106 (January 1996). In some implementations, after performing vector error diffusion, the error corrected pixel intensities can be transformed back into the RGB or RGBx color spaces. In some implementations, the vector error diffusion process outputs RGB or RGBx pixel intensity values.

The process 600 further includes generating subframes (stage 610) using the dithered pixel intensity values. Each subframe corresponds to a particular time slot in a time division gray scale image output sequence. It includes a desired state of each display element in the display for that time slot. In each time slot, a display element can take either a non-transmissive state or one or more states that allow for varying degrees of light transmission. In some implementations, the generated subframes include a distinct state value for each display element in the array of display elements 410 shown in FIG. 4.

In some implementations, the subframe generation logic 508 uses a code word lookup table (LUT) to generate the subframes (stage 610). In some implementations the code word LUT stores series of binary values referred to as code words that indicate corresponding series of display element states that result in given pixel intensity values. The value of each digit in the code word indicates a display element state (for example, light or dark) and the position of the digit in the code word represents the weight that is to be attributed to the state. In some implementations, the weights are assigned to each digit in the code word such that each digit is assigned a weight that is twice the weight of a preceding digit. In some other implementations, multiple digits of a code word may be assigned the same weight. In some other implementations, each digit is assigned a different weight, but the weights may not all increase according to a fixed pattern, digit to digit.

To generate a set of subframes (stage 610), the subframe generation logic 508 obtains code words for all pixels in a color subfield. The subframe generation logic 508 can aggregate the digits in each of the respective positions in the code words for the set of pixels in the subfield together into subframes. For example, the digits in the first position of each code word for each pixel are aggregated into a first subframe. The digits in the second position of each code word for each pixel are aggregated into a second subframe, and so forth. The subframes, once generated, are stored in the frame buffer 408 shown in FIG. 4.

In some other implementations, particularly for implementations using light modulators capable of achieving one or more partially transmissive states, the code word LUT may store code words using base-3, base-4, base-10, or some other base number scheme.

The process 600 further includes presenting the subframes for display (stage 612). Once the temperature compensated output sequence is obtained by the output logic 510 (stage 606) and the subframes for the image frame have been generated (stage 610), the output logic 510 uses the output sequence to display the subframes on the display. The output logic 510 can be configured to control output signals to a remainder of the components of the display apparatus to cause the subframes to be presented to a viewer. For example, if used in the display apparatus 128 shown in FIG. 1B, the output control logic 510 would control the output of signals to the data drivers 132, scan drivers 130 and lamp drivers 148 shown in FIG. 1B to load the subframes into the display elements in the array 150, and then to the lamp drivers 148 illuminate the display elements 150 with the lamps 140, 142, 144 and 146.

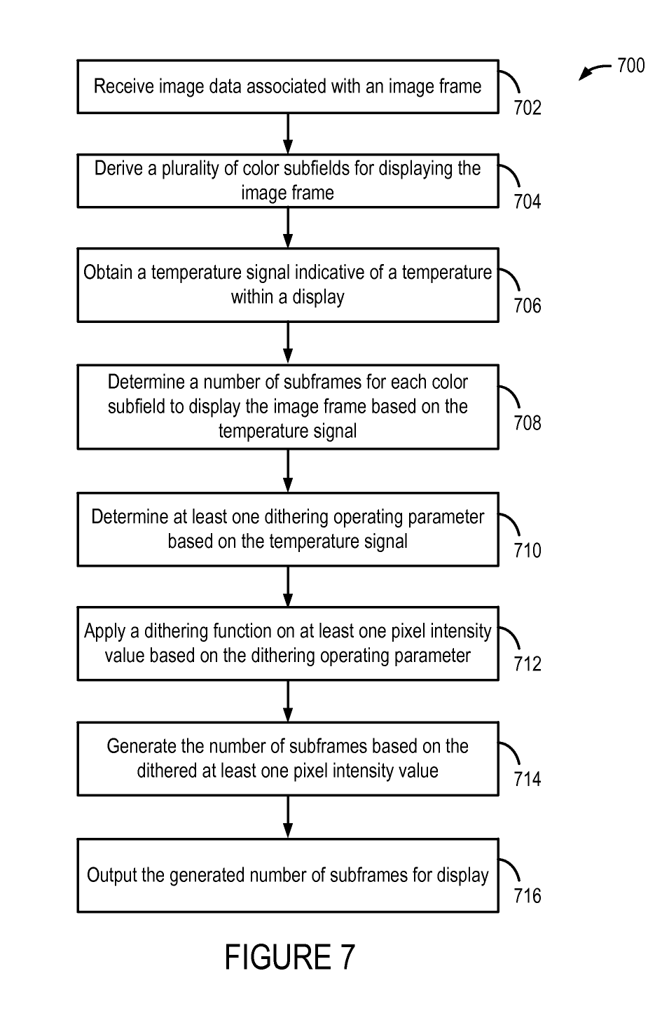

FIG. 7 shows a flow diagram of another example process 700 for displaying an image frame. In particular, the process 700 includes receiving image data associated with an image frame (stage 702), deriving a plurality of color subfields for displaying the image frame (stage 704), obtaining a temperature signal indicative of a temperature within a display (stage 706), determining a number of subframes for each color subfield to display the image frame based on the temperature signal (stage 708), determining at least one dithering operating parameter based on the temperature signal (stage 710), applying a dithering function on at least one pixel intensity value based on the dithering operating parameter (stage 712), generating the number of subframes based on the dithered at least one pixel intensity value (stage 714), and outputting the generated number of subframes for display (stage 716).

The process includes receiving image data associated with an image frame (stage 702). Examples of this process stage have been discussed above in relation to FIGS. 5 and 6. In particular, input logic 502 is configured to receive the input image data as a stream of pixel intensity values, and present the pixel intensity values to other modules within the control logic 500.

The process 700 further includes deriving a plurality of color subfields for displaying the image frame (stage 704). Examples of this process stage have been discussed above in relation to FIGS. 5 and 6. For example, in process stage 604 the subfield derivation logic 504 can derive a set of subfields colors including red, green, blue, etc. In some implementations, the subfield colors can include FICCs and x-channel colors.

The process 700 also includes obtaining a temperature signal indicative of a temperature within a display (stage 706). Examples of this process stage have been discussed above in relation to FIGS. 3 and 5. For example, the temperature compensation module 506 can receive a temperature signal from temperature sensors 350 and/or 352 indicative of the temperature of the display apparatus 300.

The process 700 further includes determining a number of subframes for each color subfield to display the image frame based on the temperature signal (stage 708). Examples of this process stage have been discussed above in relation to FIGS. 5 and 6. For example, the temperature compensation logic 506 can determine the appropriate number of subframes to generate based on the temperature of the display apparatus. In some implementations, the temperature compensation logic 506 may determine a decrease in the total number of subframes to be displayed per subfield based on a decrease in the temperature of the display apparatus.

The process 700 further includes determining at least one dithering operating parameter based on the temperature signal (stage 710). Examples of this process stage have been discussed above in relation to FIGS. 5 and 6. For example, the temperature compensation logic 506 can determine a number and weights of subframes to be displayed based on the value of the temperature signal. The number and weights of the subframes can be used by the dithering process as dithering parameters.

The process stage 700 further includes applying a dithering function on at least one pixel intensity value based on the dithering operating parameter (stage 712). Examples of this process stage have been discussed above in relation to FIGS. 5 and 6. For example, in process stage 608, the control logic 300 can perform dithering to diffuse errors in representing pixel intensity values introduced due to a possible decrease in the number of subframes. In some implementations, vector error diffusion techniques can be used to transform the RGB or RGBx pixel intensity values into vector color space pixel intensity values and diffuse the error for each pixel among neighboring pixels within the vector color space.

The process 700 also includes generating the number of subframes based on the dithered at least one pixel intensity value (stage 714). Examples of this process stage have been discussed above in relation to FIGS. 5 and 6. For example, in process stage 610, the subframe generation logic 508 can generate a set of subframes based on an output sequence and the dithered intensity values for each subfield color for each pixel. The subframe generation logic 508 can store the generated subframes in a frame buffer.

The process 700 further includes outputting the generated number of subframes for display (stage 716). Examples of this process stage have been discussed above in relation to FIGS. 5 and 6. For example, in process stage 612, the output logic 510 can output the series of subframes stored in the frame buffer to the display elements of the display apparatus based on the output sequence.

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
an input configured to receive image data associated with an image frame; and
control logic configured to:
derive a plurality of color subfields for displaying the image frame;
determine a number of subframes within each color subfield to display the image frame based on a temperature signal indicative of a temperature within the apparatus,
determine at least one dithering operating parameter based on the temperature signal;
perform a dithering operation on at least one pixel intensity value based on the dithering operating parameter;
generate the number of subframes based on the dithered at least one pixel intensity value; and
output the generated subframes.

2. The apparatus of claim 1, further comprising a temperature sensor for sensing the temperature of the apparatus and providing the temperature signal to the control logic.

3. The apparatus of claim 1, wherein the temperature signal is indicative of a temperature within a fluid surrounding a plurality of display elements of the apparatus.

4. The apparatus of claim 1, wherein the dithering operation includes a vector error diffusion algorithm performed within a vector color space.

5. The apparatus of claim 1, wherein the control logic is further configured to determine a drive current for one or more light sources used for displaying the image frame based on the temperature signal.

6. The apparatus of claim 1, wherein the control logic is further configured to determine drive voltages for driving a plurality of light modulators of the apparatus based on the temperature signal.

7. The apparatus of claim 1, wherein the control logic if further configured to determine data voltages and scan line voltages based on the temperature signal.

8. The apparatus of claim 1, wherein the control logic is further configured to determine timings with which the subframes are outputted based on the temperature of the apparatus.

9. The apparatus of claim 1, further comprising:
a display including the input, the control logic, the flicker control logic, the subfield and subframe generation logic and the output logic;
a processor that is capable of communicating with the display, the processor being capable of processing image data; and
a memory device that is capable of communicating with the processor.

10. The apparatus of claim 9, the display further including:
a driver circuit capable of sending at least one signal to the display; and
a controller capable of sending at least a portion of the image data to the driver circuit.

11. The apparatus of claim 9, the display further including:
an image source module capable of sending the image data to the processor, wherein the image source module comprises at least one of a receiver, transceiver, and transmitter.

12. The apparatus of claim 9, the display further including:
an input device capable of receive input data and to communicate the input data to the processor.

13. A method for mitigating flicker in a display, comprising:
receiving image data associated with an image frame;
deriving a plurality of color subfields for displaying the image frame;
obtaining a temperature signal indicative of a temperature within the display;
determining a number of subframes for each color subfield to display the image frame based on the temperature signal;
determining at least one dithering operating parameter based on the temperature signal;
applying a dithering function on at least one pixel intensity value based on the dithering operating parameter;
generating the number of subframes based on the dithered at least one pixel intensity value; and
outputting the generated number of subframes for display.

14. The method of claim 13, wherein applying a dithering function on the at least one pixel intensity value based on the dithering operation parameter includes applying vector error diffusion in a vector color space to the at least one pixel intensity value based on the dithering operation parameter.

15. The method of claim 13, wherein the dithering operation parameter includes the number of subframes.

16. The method of claim 13, further comprising determining a drive current for one or more light sources used for displaying the image frame based on the temperature signal.

17. The method of claim 13, wherein outputting the generated number of subframes includes determining timings with which the subframes are output based on the temperature signal.
